(19) United States
(12) Patent Application Publication
(10) Pub. No.: US 2015/0057057 A1
(43) Pub. Date: Feb. 26, 2015

(54) System and method for electronic tag game

(71) Applicant: Aaron Fischer, Greenfield, WI (US)

(72) Inventor: Aaron Fischer, Greenfield, WI (US)

(21) Appl. No.: 13/972,985

(22) Filed: Aug. 22, 2013

(51) Int. Cl. F41G 3/26; A63F 13/30

(52) U.S. Cl. CPC F41G 3/2655; A63F 13/12
USPC 463/7; 463/51

(57) ABSTRACT

The invention is directed to a system and method of a lasertag game. The invention utilizes a plethora of handheld gaming devices, each of which operate in tandem with a respective wireless cellular device. During game play a handheld gaming device receives an infrared signal. Each handheld gaming device utilizes the wireless cellular device operating in tandem with it to transmit and receive game play information to the other handheld gaming devices utilized by other players. The invention also utilizes a server connected to a database and client computers to allow users to manipulate and enhance game play.

### FIELD OF THE INVENTION

The invention relates to competitive electronic gaming, and in particular an apparatus, system, and method for utilizing a mobile cellular phone in conjunction with a firearm-like device for a gaming system.

### BACKGROUND OF THE INVENTION

Laser tag is a very popular game and is known in the prior art. Historically, a laser tag system has utilized multiple firearm-like devices or “guns”. The guns incorporate an infrared emitter and an infrared receptor. The infrared receptor may be incorporated into the gun or within a separate device connected to the gun through a wire or wireless means. Normally the infrared receptor is worn as a separate device on a player's chest, arm, or head. A player aims his gun at another player and pulls the trigger. The trigger activates the infrared emitter on the gun. The infrared signal travels toward the infrared receptor worn by the other player. If the infrared signal activates the infrared receptor then a signaling means is activated. The signaling means is intended to inform the player that the player has been “hit.” The signaling means is normally a vibration, a flashing light, or an audible sound. Optionally, a player's gun may become deactivated when the player is hit. Laser tag systems can utilize a plethora of guns simultaneously. In such a system each gun normally gets a limited number of “shots.” Multiple players can engage in a game. Such games can either be a “free for all” or players can form teams. Normally, when a player hits another player, there is no way for the shooter to know that the other player has been hit. Only if the shooter hears the audible signal, or sees the flashing light, will the shooter know that the he has hit the other player.

Variations of this system have been developed to enhance game play. Software has been configured for guns to alter firing rates, reloads, hit points, number of shots, firing modes, and sounds associated with firing. Alternatively, variations in hardware have been developed to alter the game play. This includes changing the spread of the angle of the infrared beam with a lens.

Wireless cellular devices, such as cell phones and ipads, are ubiquitous. These devices can be utilized for game play among multiple users through software applications. These software applications do not require users to incorporate additional devices with their wireless cellular devices. There is no existence in the prior art of the use of wireless cellular devices, such as cell phones or ipads, being connected with laser tag guns and utilized as an integral part of the device during game play.

The prior art is limited because there is no way for a shooter to directly know that he has acquired a hit. Furthermore, there has been no way for users to alter the game play in a system in an easy method. What is needed is a means for users to receive real time information as to the status of additional players during game play. What is needed is a way for users to easily and effectively engage in enhanced game play by utilizing the signaling and computing ability of personal wireless cellular devices.

### SUMMARY OF THE INVENTION

The invention is directed toward a device, system, and method for a lasertag game. The invention includes a handheld device for use in a lasertag game comprising a wireless communications means, a directional infrared transmitter, and an omni-directional field of view receiver to receive an infrared signal. The handheld device transmits and receives game play information with a wireless cellular device. The device may further comprise a shaped recess to receive and retain a wireless cellular device.

In another embodiment the device further comprises a power source, a trigger, a vibrator, and a reload button. Optionally, the device may further include a speaker, a headset port, and a display screen. The device may further comprise a shaped recess to receive and retain a wireless cellular device. The wireless cellular device transmits and receives game play information with a plethora of other wireless cellular devices active within the game of play. Furthermore, the handheld gaming device may be formed in the shape of a firearm.

The invention is also directed to a gaming system comprising one or more handheld gaming devices and one or more wireless cellular devices. Each wireless cellular device operates in tandem with a respective handheld gaming device. The handheld gaming device transmits and receives game play information with its respective wireless cellular device. In this system, each handheld gaming device comprises a wireless communications means, a directional infrared signal, and an omni-directional field of view receiver to receive an infrared signal. In one embodiment of the system each wireless cellular device transmits and receives game play information directly with the other wireless cellular devices active within the game. This direct transfer of information may be through any communication means inherent in the wireless cellular device. Preferably the direct communication of the wireless cellular devices occurs through a cellular network.

In another embodiment, the system further comprises a server computer and a client computer. In this embodiment, each wireless cellular device transmits and receives game play information with the server computer. A user may access game play information, or control the game play environment, in real time via the client computer. Optionally, the system may further comprise a database connected to the server computer and an administrator device. The database stores game play information. A user may retrieve and review historical game play information via said client computer. The administrator device allows a game administrator to manipulate and control the game settings and the play of the game.

The invention is also directed toward a method of game play. The method of game play comprises connecting one or more wireless cellular devices to operate respectively in tandem with one or more handheld gaming devices and allowing one or more handheld gaming devices to interact during gameplay. The gameplay comprises each player aiming a handheld gaming device at other players, each player pulling the trigger on that individual's handheld gaming device, the handheld gaming devices emitting infrared beams when the trigger is pulled, and the infrared beam of a player's handheld gaming device being detected by another player's handheld gaming device.

In one embodiment of the invention, the method may further comprise changing the state of game play of a first handheld gaming device when the first handheld gaming device detects the infrared beam emitted from a second handheld gaming device operated by another player, transmitting information regarding the change in the state of game play from the first handheld gaming device to the wireless cellular device operating in tandem with the first handheld gaming device, transmitting information regarding the change in state of game play from the wireless cellular device to a server via a public network, and transmitting the information regarding the change in state of game play from the server to the wireless cellular device operating in tandem with the second handheld gaming device. The method may further comprise transmitting the information regarding the change in state of game play from said server to the wireless cellular devices of all players. Optionally, the method may further comprise storing game play information on a database connected to the server. Optionally, the method may further comprise signaling when a handheld gaming device detects an infrared signal by emitting an auditory signal and signaling when a handheld gaming device detects an infrared signal by causing the handheld gaming device to vibrate. Optionally, the method may further comprise displaying game related information on the display screens of the wireless cellular devices.

In another embodiment, the method further comprises transmitting the information regarding the change in state of game play from said server to the wireless cellular devices of all players, storing game play information on a database connected to said server, signaling when a handheld gaming device detects an infrared signal by emitting an auditory signal, signaling when a handheld gaming device detects an infrared signal by causing the handheld gaming device to vibrate, displaying game related information on the display screens of the wireless cellular devices, utilizing the software and hardware of said wireless cellular devices to enhance the play of the game, and manipulating and controlling the game settings and play of the game via an administrator device.

In another embodiment of the invention the method further comprises changing the state of game play of a first handheld gaming device when the first handheld gaming device detects the infrared beam emitted from a second handheld gaming device operated by another player, transmitting information regarding the change in the state of game play from the first handheld gaming device to the wireless cellular device operating in tandem with the first handheld gaming device, transmitting information regarding the change in state of game play from the wireless cellular device operating in tandem with the first handheld gaming device to the wireless cellular device operating in tandem with the second handheld gaming device, and transmitting information regarding the change in the state of game play from the wireless device operating in tandem with the second handheld gaming device to the second handheld gaming device. Optionally, this embodiment may further comprise transmitting the information regarding the change in state of game play from the server to the wireless cellular devices of all players, storing game play information on a database connected to the server, signaling when a handheld gaming device detects an infrared signal by emitting an auditory signal, signaling when a handheld gaming device detects an infrared signal by causing said handheld gaming device to vibrate, displaying game related information on the display screens of said wireless cellular devices, utilizing the software and hardware of said wireless cellular devices to enhance the play of the game, and manipulating and controlling the game settings and play of the game via an administrator device.

The wireless cellular device utilized in the invention may be any type of portable computing device capable of transmitting and receiving information wirelessly. In the preferred embodiment, the invention utilizes a cellular phone. However, the invention may use a tablet computer or ipad as well.

In addition, the invention utilizes the enhanced capabilities of the wireless cellular device to enhance game play. The invention can utilize the GPS system of the wireless cellular device. The game administrator may establish rules to be set which utilize the GPS unit in each individual wireless cellular device involved in game play. In one embodiment, the game administrator may create a virtual game map and virtual map layout through which the plethora of game players may move. In this embodiment, the game administrator may establish map boundaries around a geographic outdoor area to operate as the game arena. As the players move throughout the arena, the GPS unit in each wireless cellular device transmits the precise location of the respective player to the game system. The game system then places the location of each respective player on a virtual map of the arena. The system may then transmit the map information to each respective player. In this way a play may see his/her location on the virtual map in association with the locations of the other players. The game administrator may have the option of granting a player access to the location information of all other players or may limit the information provided to a player, such as only showing the location information of those players who are on the same team.

Additional game enhancements are available through utilization of the GPS features of the wireless cellular devices. Such enhancements include placing a specific weapon upgrade at a specific location on the virtual map. When a player reaches the GPS location of the weapon upgrade then that player's handheld gaming device incorporates the weapon upgrade. The player may then utilize the weapon upgrade as desired. Another enhancement includes the ability for a player to call in an “air strike.” In this enhancement a player may have the game system deduct hit points from all opposing players in a specific area on the virtual game map. Other game enhancements include utilizing the GPS units of the wireless cellular devices to play “capture the flag.” In this enhancement, each of two or more teams may establish a home base and set a flag at a specific GPS location on the virtual game map. When a player from an opposing team reaches the GPS location of the home base, the opposing player has “captured the flag” of the team. The capture is confirmed through the GPS unit of the capturing player. The guns of the team whose base has been captured are then deactivated by the system.

The system further comprises utilizing the telecommunication capabilities of the wireless cellular devices working in tandem with the guns. Players may wear earphones or headset devices which are connected to the wireless cellular device via a wire or wireless signal. Players may then talk directly with other players engaged in game play. The system may be set up so that all players may speak with each other at once or only those players who are on the same team may speak with other.

The system may be set up so that the players may engage in game play in an “offline” mode. In this mode the signals from the wireless cellular devices do not transmit to the system during game play. All game relevant information and game activity are stored on the memory storage components of the respective wireless cellular devices of the players. The offline game mode can be used if the players are engaging in an outdoor game where the players may be outside of the range of local cellular towers and may not be able to receive a signal. After players are finished with game play and are later within range of a cellular tower, the system uploads game play information into the system. The results may be uploaded automatically, or may be uploaded when a player chooses to upload the game relevant information to the system. Players may then log into the system from a computer or web enabled device to view relevant game information and analyze the results of the game.

The game play enhancements include a social media aspect of game play. Players can connect to the system through a client computer connected to the system through the internet. A player creates a user profile within the system and can connect with other friends within the system. The system allows players to create new game parameters, such as a unique game play map, limited time play, certain weapon parameters, and any other limitations or parameters as established by the player. The player can then share the game parameters with other players. This allows other players to host the game created by the first player. In addition, players can share game statistics with other players. The players can be ranked through the system based on game statistics and the game performance of the players. The system also allows players to share relevant game information to others through conventional social networking websites such as facebook or twitter.

The invention includes the capability of utilizing a mobile application installed on the wireless cellular device to manage and enhance game play. In one embodiment there may be a bomb placed at a specific location on the virtual game map. When a player reaches the specific GPS location on the virtual map, the player must “diffuse” the bomb by entering a specific number code into the wireless cellular device that is connected in tandem with that player's gun.

The system further allows control of the guns and game play through an administrator device. The administrator device may be any web enabled computer device such as a desktop computer, a laptop, a tablet computer or a cell phone. The administrator device may be utilized to control the guns being utilized in game play. In normal game play when utilizing multiple guns, one player must aim his gun at the receiver of another player and shoot a reset signal. The other player shoots a reset signal at the receiver of the first player. After the players have reset the guns the players may commence game play. This process is called “syncing” the guns. When playing a game with more than two members, beginning game play becomes tedious because each member must shoot a reset signal at every other player's receiver. The administrator device allows users to bypass this system. The game host or game administrator can push out a text message and every phone which receives the text message becomes synced together. The automatic syncing of all of the guns is faster and easier than the normal process of syncing the guns one person at a time.

The administrator device may also have an enhanced administrator interface system which allows the game administrator to have immediate and complete control over the game system and all guns utilized during game play. The enhanced control system permits the administrator to utilize a graphical user interface to control and manipulate the play of the game. The enhanced control system allows the system administrator to assign teams and start the game with a simplistic user interface or at the touch of a button. For instance, the administrator may view all guns in the system that are active and inactive. The administrator can drag and drop specific functionality to any active gun before or during gameplay. The administrator may also drag and drop specific guns into team slots and assign multiple users to two or more teams. The enhanced control system allows the administrator to activate and deactivate guns individually by selecting a graphical icon of the desired gun. Likewise, the administrator may activate all guns simultaneously by a click of an activate button.

### BRIEF DESCRIPTION OF THE DRAWINGS

FIG. 1 is a view of the gaming system.

FIG. 2 is an exploded view of the handheld gaming device.

### DETAILED DESCRIPTION OF THE DRAWINGS

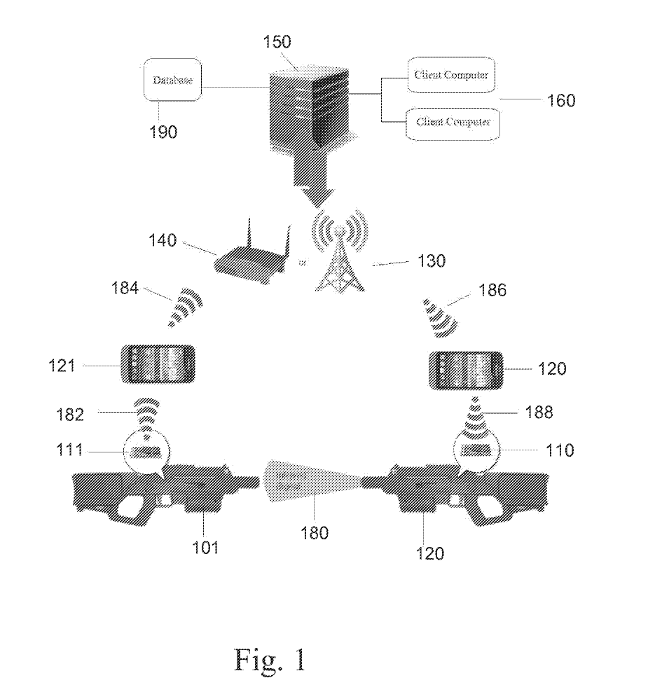

FIG. 1 shows the preferred embodiment of the invention. A first hand held gaming device 100 is used by one player. The first hand held gaming device 100 incorporates a first wireless transmitting module 110. The first hand held gaming device is in tandem with a first wireless cellular device 120. The player pulls a trigger on the first hand held gaming device 100, activating a directional infrared transmitter incorporated into the first hand held gaming device 100. The directional infrared transmitter emits an infrared signal 180. The first user aims the infrared signal 180 at a second hand held gaming device 101. The second hand held gaming device 101 incorporates an omni-directional field of view receiver to receive the infrared signal 180. The omni-directional field of view receiver to receive the infrared signal may be housed within the second hand held gaming device or optionally may be housed in a separate holder to be worn by the second player. When the omni-directional field of view receiver receives the infrared signal 180, the omni-directional field of view receiver registers a hit. The omni-directional field of view receiver activates circuitry incorporated into the second hand held gaming device 101. The circuitry activates a second wireless transmitting module 111. The wireless transmitting module 111 transfers game relevant information by means of a first wireless signal 182 to a second wireless cellular device 121. The second wireless cellular device 121 retransmits game relevant information by means of a second wireless signal 184 to a wireless router 140. Optionally, the second wireless cellular device 121 may retransmit game relevant information to a cell phone data tower 130. The wireless router 140 or the cell phone data tower 130 retransmits game relevant information to the first wireless cellular device 120 by means of a third wireless signal 186. The first wireless cellular device 120 retransmits game relevant information to the first wireless transmitting module 110 by means of a fourth wireless signal 188. The first wireless transmitting module 110 activates circuitry incorporated in the first hand held gaming device 100.

The wireless router 140 or cell phone data tower 150 may transmit game relevant information to a server 150. The server 150 may be connected with a database 190 allowing for storage and retention of game relevant information. Optionally, a plethora of client computers 160 are connected to the server 150 via the Internet. Users may utilize a client computer 160 to modify game play. A user may use a client computer 160 to establish teams, assign gun modes, create game goals, create time limits, and other actions to enhance game play. Likewise, a user may view and analyze relevant game play information retrieved by the system and stored on the database 190 after game play has finalized.

The game relevant information may include any data or information which is pertinent to the game play. Such game relevant information may include shots taken, identity of players involved in game play, hit points, hit accuracy, lives lost, weapon type, special attacks, upgrades, or any other information created or utilized during game play.

Optionally, the wireless cellular devices 120, 121 may be utilized to enhance game play. The wireless cellular devices 120, 121 may display relevant game play information on the display screens.

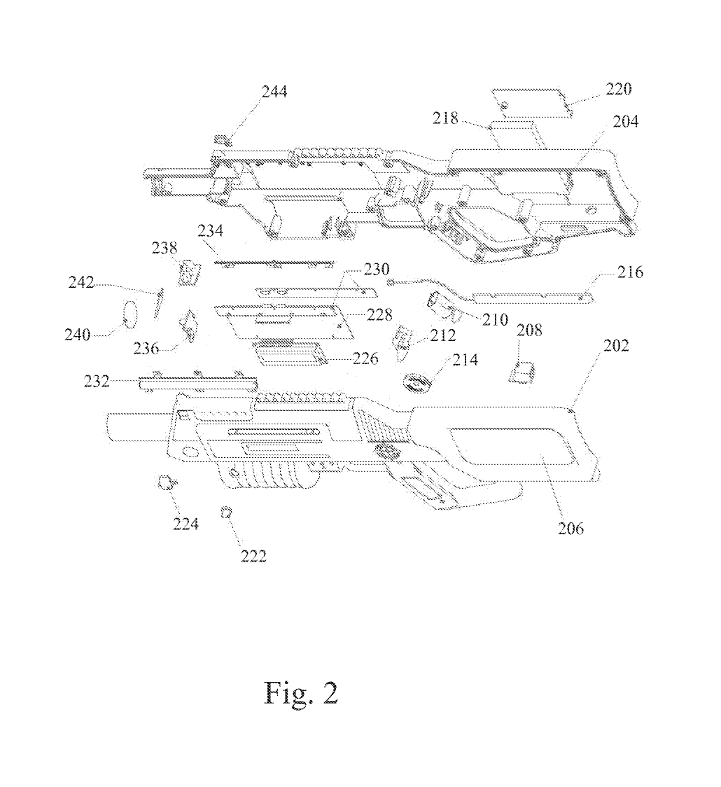

FIG. 2 shows one embodiment of the handheld gaming device. The handheld gaming device has a left side 202 and a right side 204. The handheld gaming device has a shaped recess 206 to receive and retain a wireless cellular device. The device has a battery 218 power source and a battery cover 220. The device also has a trigger 212, a speaker 214, a vibrator 210, a connection port for a head sensor 208, and a reload button 222. The device has a means of communicating wirelessly. In this embodiment the device has a WiFi antenna 216 and a transceiver 238. The device has an infrared emitter. The emitter includes a directional lens 232, 234 which emits an infrared beam through a focus lens 240. The device includes a printed circuit board for controlling the LCD display screen on the handheld device 226, a primary printed circuit board for running software on the device 228, a printed circuit board for controlling the infrared emitter 230, and a printed circuit board to control the transmission of game related information 236. The device includes a multi-directional infrared receiver which includes a left sensor lens 224 and a right sensor lens 244. The device also includes an LED lens 242.

1. A handheld device for use in a lasertag game comprising
A wireless communications means
A directional infrared transmitter
An omni-directional field of view receiver to receive an infrared signal
Wherein said handheld device transmits and receives game play information with a wireless cellular device.

2. The device as in claim 1 further comprising
A shaped recess to receive and retain a wireless cellular device

3. The device as in claim 1 further comprising
A power source
A trigger
A vibrator
A reload button

4. The device as in claim 3 further comprising
A speaker
A headset port
A display screen

5. The device as in claim 4 further comprising
A shaped recess to receive and retain a wireless cellular device

6. The device as in claim 5 wherein said wireless cellular device transmits and receives game play information with a plethora of other wireless cellular devices active within the game of play

7. The device as in claim 6 wherein the handheld gaming device is in the shape of a firearm

8. A gaming system comprising
One or more handheld gaming devices, each handheld gaming device comprising
A wireless communications means
A directional infrared transmitter
An omni-directional field of view receiver to receive an infrared signal
Wherein each handheld device transmits and receives game play information with a respective wireless cellular device.
One or more wireless cellular devices

9. The gaming system as in claim 8 wherein each wireless cellular device transmits and receives game play information directly with other wireless cellular devices active within the game

10. The gaming as in claim 8 further comprising
A server computer
A client computer
Wherein each said wireless cellular device transmits and receives game play information with the server computer
Wherein a user may access game play information, or control the game play environment, in real time via said client computer

11. The gaming system as in claim 10 further comprising
A database
Wherein said database is connected to said server computer
Wherein said database stores game play information
Wherein a user may retrieve and review historical game play information via said client computer.
An administrator device
Wherein said administrator device is utilized to manipulate and control the game settings and the play of the game

12. The method of game play comprising
Connecting one or more wireless cellular devices to operate respectively in tandem with one or more handheld gaming devices
Allowing one or more handheld gaming devices to interact during gameplay Said gameplay comprising
Each player aiming a handheld gaming device at other players
Each player pulling the trigger on that individual's handheld gaming device
Said handheld gaming device emitting an infrared beam
Said infrared beam detected by another player's handheld gaming device

13. The method as in claim 12 further comprising
Changing the state of game play of a first handheld gaming device when said first handheld gaming device detects the infrared beam emitted from a second handheld gaming device operated by another player
Transmitting information regarding the change in the state of game play from said first handheld gaming device to the wireless cellular device operating in tandem with said first handheld gaming device
Transmitting information regarding the change in state of game play from said wireless cellular device to a server via a public network
Transmitting the information regarding the change in state of game play from the server to the wireless cellular device operating in tandem with said second handheld gaming device

14. The method as in claim 13 further comprising
Transmitting the information regarding the change in state of game play from said server to the wireless cellular devices of all players

15. The method as in claim 13 further comprising
Storing game play information on a database connected to said server

16. The method as in claim 13 further comprising
Signaling when a handheld gaming device detects an infrared signal by emitting an auditory signal
Signaling when a handheld gaming device detects an infrared signal by causing said handheld gaming device to vibrate.

17. The method as in claim 13 further comprising
Displaying game related information on the display screens of said wireless cellular devices

18. The method as in claim 13 further comprising
Transmitting the information regarding the change in state of game play from said server to the wireless cellular devices of all players
Storing game play information on a database connected to said server
Signaling when a handheld gaming device detects an infrared signal by emitting an auditory signal
Signaling when a handheld gaming device detects an infrared signal by causing said handheld gaming device to vibrate
Displaying game related information on the display screens of said wireless cellular devices
Utilizing the hardware and software of said wireless cellular devices to enhance the play of the game
Manipulating and controlling the game settings and play of the game via an administrator device

19. The method as in claim 12 further comprising
Changing the state of game play of a first handheld gaming device when said first handheld gaming device detects the infrared beam emitted from a second handheld gaming device operated by another player
Transmitting information regarding the change in the state of game play from said first handheld gaming device to the wireless cellular device operating in tandem with said first handheld gaming device
Transmitting information regarding the change in state of game play from said wireless cellular device operating in tandem with said first handheld gaming device to the wireless cellular device operating in tandem with said second handheld gaming device
Transmitting information regarding the change in the state of game play from said wireless device operating in tandem with said second handheld gaming device to said second handheld gaming device

20. The method as in claim 19 further comprising
Transmitting the information regarding the change in state of game play from said server to the wireless cellular devices of all players
Storing game play information on a database connected to said server
Signaling when a handheld gaming device detects an infrared signal by emitting an auditory signal
Signaling when a handheld gaming device detects an infrared signal by causing said handheld gaming device to vibrate
Displaying game related information on the display screens of said wireless cellular devices
Utilizing the hardware and software of said wireless cellular devices to enhance the play of the game
Manipulating and controlling the game settings and play of the game via an administrator device
